(19) United States
(12) Patent Application Publication
(10) Pub. No.: US 2018/0142766 A1
(43) Pub. Date: May 24, 2018

(54) INTELLIGENT PUMPING UNIT WITH SPROCKET FORCE REDUCTION SYSTEM

(71) Applicant: Maorong Li, Beijing (CN)

(72) Inventor: Maorong Li, Beijing (CN)

(73) Assignee: FORLAND GROUP INC., HOUSTON, TX (US)

(21) Appl. No.: 15/359,390

(22) Filed: Nov. 22, 2016

(51) Int. Cl. F16H 19/06; F04B 53/14

(52) U.S. Cl. CPC F16H 19/0604; F04B 53/14

(57) ABSTRACT

The invention discloses an intelligent pumping unit with a sprocket force reduction system; the intelligent pumping unit further comprises an upper fixing end, a lower fixing end and a chain; the upper fixing end and the lower fixing end act as a starting end and a terminal end for fixing the chain.

### CROSS-REFERENCE TO RELATED APPLICATIONS

The present application claims priority under 35 U.S.C. § 119 to Chinese patent application 201610197566.7, filed on Mar. 31, 2016, the disclosure of which is incorporated herein by reference.

### BACKGROUND

### Field of the Invention

The present invention relates to an intelligent pumping unit with a sprocket force reduction system, that belongs to the technical field of mechanical equipment.

### Background of the Invention

A pumping unit is a machine which continuously runs under a heavy load for a long time. When the pumping unit employs a sprocket-chain transmission structure, due to the fact that the pumping unit itself is a heavy-load machine, the heavy load will cause excessive loads on a sprocket and a chain, and the excessive loads on some components will shorten the service life of the machine during the mechanical transmission, thus the requirements of long-period operation of the pumping unit under the heavy load can hardly be satisfied. Meanwhile, the design of large-load machine types will be limited.

During the entire transmission process of the pumping unit, and in the transmission process that the power from an electric motor is delivered to the load, the sprocket and the chain at an output shaft of a reducer will be the transmission components where the load from the entire power transmission is concentrated; the sprocket and the chain will be a high-load section of the entire power transmission, thereby causing imbalance to the entire power transmission; and the imbalance of power transmission will increase the fault rate of the high-load components, and affect the service life of the entire unit.

### SUMMARY OF THE INVENTION

The present invention seeks to solve the technical problem aforementioned by providing an intelligent pumping unit with a sprocket force reduction system. The intelligent pumping unit is provided with the sprocket force reduction structure which solves the problem of large load on high-duty transmission components such as the sprocket and the chain of the pumping unit, and halves the load on the sprockets and the chain, thus the design and production of large-load types can be achieved, the load on the transmission components of the entire pumping unit is better balanced, therefore it reduces the fault rate and greatly increases the reliability and service life of the entire unit.

To solve the technical problem above, the following technical solution will be adopted by the present invention:

The intelligent pumping unit with the sprocket force reduction system is characterized in that: 1. the intelligent pumping unit comprises the sprocket force reduction system wherein a chain is flexible only in a single direction.

Furthermore, the sprocket force reduction system comprises a driving sprocket, a transitional sprocket, a first driven sprocket and a second driven sprocket inside a counter weight box, and the chain for connecting each sprocket.

In addition, the intelligent pumping unit comprises an upper fixing end, a lower fixing end and a chain, the upper fixing end and the lower fixing end act as a starting end and a terminal end for fixing the chain.

Furthermore, a first end of the chain is fixed at the upper fixing end, a second end of the chain hangs down from the upper fixing end and is connected with the first driven sprocket.

In addition, the second end of the chain passes through the first driven sprocket and is connected with the transitional sprocket.

Furthermore, the second end of the chain passes through the transitional sprocket and is connected with the driving sprocket.

In addition, the second end of the chain passes through the driving sprocket and is connected with the second driven sprocket.

In addition, the second end of the chain passes through the second driven sprocket and is connected with the lower fixing end.

Furthermore, the intelligent pumping unit further comprises a rack, the upper fixing end is arranged at an upper end of the rack, and the lower fixing end is arranged at a lower end of the rack.

In addition, the intelligent pumping unit further comprises a counter weight box, the first driven sprocket is installed at an upper end inside the counter weight box, and the second driven sprocket is installed at a lower end inside the counter weight box. The pumping unit of the present invention has the advantages as follows:

Based on the fundamental principles of movable blocks in connection with characteristics of the chain, the unit is provided with the sprocket force reduction structure which solves the problem of the large load on high-duty transmission components such as the sprocket and the chain of the pumping unit, and halves the load on the sprockets and the chain, thus the design and production of large-load types can be achieved, the load on the transmission components of the entire pumping unit is better balanced, thereby reducing the fault rate and greatly increasing the reliability and service life of the entire unit.

Due to the fact that the load on the transmission components of the entire unit is better balanced, the energy-saving effect of the entire unit is more prominent, with 20% and more energy being saved.

The present invention will be described in detail hereinafter in connection with the drawings and embodiments.

### BRIEF DESCRIPTION OF THE FIGURES

FIG. 1 is a schematic diagram of a structure for an intelligent pumping unit in an embodiment of the present invention;

In the diagram: 1—electric motor, 2—reducer, 3—driving sprocket, 4—lower fixing end, 5—upper fixing end, 6—transitional sprocket, 7—roller, 8—load belt, 9—sucker rod, 10—counter weight box, 11—first driven sprocket, 12—second driven sprocket, 13—chain.

### DESCRIPTION OF THE INVENTION

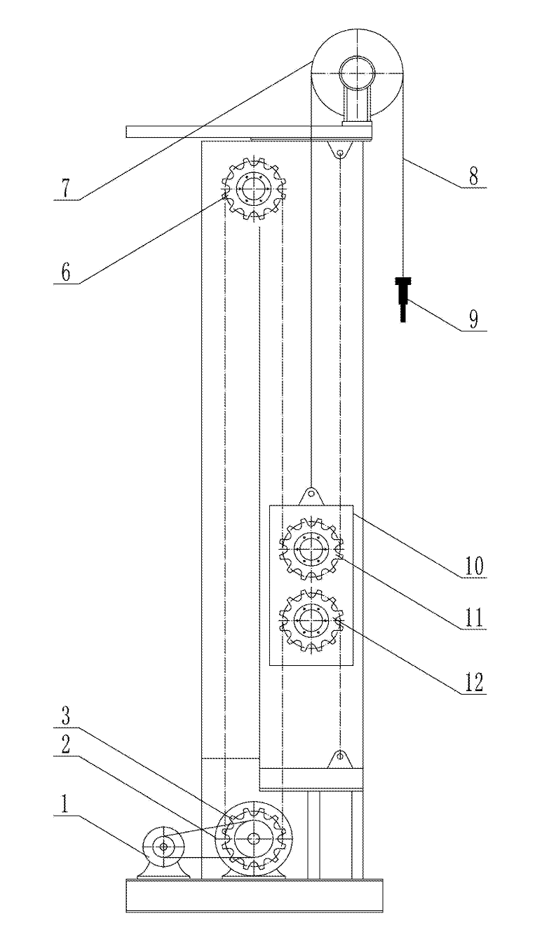

Embodiment 1, as shown in FIG. 1, an intelligent pumping unit with a sprocket force reduction system comprises a pedestal, wherein an electric motor 1 and a reducer 2 are installed on the pedestal, the electric motor 1 drives the reducer 2 to revolve through a belt, and a driving sprocket 3 is installed on an output shaft of the reducer 2.

The intelligent pumping unit further comprises a counter weight box 10, a first driving sprocket 11 is installed at an upper end inside the counter weight box 10, a second driven sprocket 12 is installed at a lower end inside the counter weight box 10, and the second driven sprocket 12 is connected with the driving sprocket 3 through the chain 13.

The intelligent pumping unit further comprises a rack, a roller 7 is installed on a platform on top of the rack, a load belt 8 is supported by the roller 7, a first end of the load belt 8 is connected with the counter weight box 10, and a second end of the load belt 8 is connected with a sucker rod 9.

A transitional sprocket 6 is installed at a top end of the rack, the transitional sprocket 6 is connected with the driving sprocket 3 and the first driven sprocket 11 through the chain 13.

The intelligent pumping unit further comprises an intelligent control system which is integrated inside a control cabinet that is installed in a reasonable position nearby the electric motor 1.

The intelligent pumping unit further comprises the sprocket force reduction system wherein the chain (13) is flexible only in a single direction; the sprocket fore reduction system comprises the driving sprocket 3, the transitional sprocket 6, the first driven sprocket 11 and the second driven sprocket 12 inside the counter weight box 10, and the chain 13 for connecting each of the sprockets.

The intelligent pumping unit further comprises an upper fixing end 5 and a lower fixing end 4, the upper fixing end 5 is arranged at an upper end of the rack, the lower fixing end 4 is arranged at a lower end of the rack, the upper fixing end 5 and the lower fixing end 4 act as a starting end and a terminal end for fixing the chain 13.

The chain 13 is fixed at the upper fixing end 5, a second end of the chain 13 hangs down from the upper fixing end 5 and is installed on the first driven sprocket 11, the second end of the chain 13 passes through the first driven sprocket 11 and is installed on the transitional sprocket 6, the second end of the chain 13 passes through the transitional sprocket 6 and is connected with the driving sprocket 3, the second end of the chain 13 passes through the driving sprocket 3 and is connected with the second driven sprocket 12, the second end of the chain 13 passes through the second driven sprocket 12 and is fixed at the lower fixing end 4.

The sprocket structure consisting of the first driven sprocket 11 and the second driven sprocket 12 on the counter weight box 10 is the technological core of the sprocket force reduction structure; through this mechanical structure, half of the power will be saved when the driving sprocket drives the counter weight box to work, thereby greatly reducing the load on the driving sprocket, greatly reducing the load torque of the reducer, and realizing the miniaturization of thereducer.

The collaboration between the counter weight box 10 and the load belt 8 will reduce half of the load on the sprockets and the chain.

Operating principle: when the driving sprocket rotates, it drives the counter weight box to move by the chain; when the sprocket rotates anticlockwise, it drives the upper sprocket of the counter weight box to rotate clockwise through the transmission of the driven wheel at the upper end of the rack, thereby driving the counter weight box to move upward along the rack; when the driving sprocket rotates clockwise, it drives the lower sprocket of the counter weight box to rotate anticlockwise through the chain, thereby driving the counter weight box to move downward along the rack. The operation of the pumping unit is achieved by the anticlockwise and clockwise rotations of the electric motor.

The example of the most preferred embodiment of the present invention is described above, in which the parts not detailed therein are commonly known to persons skilled in the art. The scope of protection of the present invention shall be based on the contents of the Claims, and any equivalent transformation based on the technical teachings of the present invention shall fall within the scope of protection of the present invention.

We claim:

1. An intelligent pumping unit, comprising a sprocket force reduction system which is provided with a chain that is flexible only at a single direction.

2. The intelligent pumping unit according to claim 1, wherein the sprocket force reduction system further comprises a driving sprocket, a transitional sprocket, a first driven sprocket and a second driven sprocket inside a counter weight box, and the chain for connecting each of the sprockets.

3. The intelligent pumping unit according to claim 2, further comprising an upper fixing end and a lower fixing end, wherein the upper fixing end and the lower fixing end act as a starting end and a terminal end for fixing the chain.

4. The intelligent pumping unit according to claim 3, wherein a first end of the chain is fixed at the upper fixing end, a second end of the chain hangs down from the upper fixing end and is connected with the first driven sprocket.

5. The intelligent pumping unit according to claim 3, wherein an end of the chain passes through the first driven sprocket and is connected with a transitional sprocket.

6. The intelligent pumping unit according to claim 2, wherein an end of the chain passes through a transitional sprocket and is connected with the driving sprocket.

7. The intelligent pumping unit according to claim 2, wherein an end of the chain passes through the driving sprocket and is connected with the second driven sprocket.

8. The intelligent pumping unit according to claim 3, wherein an end of the chain passes through the second driven sprocket and is fixed at the lower fixing end.

9. The intelligent pumping unit according to claim 3, further comprising a rack, the upper fixing end is arranged at an upper end of the rack, and the lower fixing end is arranged at a lower end of the rack.

10. The intelligent pumping unit according to claim 2, wherein the first driven sprocket is installed at an upper end inside the counter weight box, and the second driven sprocket is installed at a lower end inside the counter weight box.
